(19) United States
(12) Patent Application Publication
(10) Pub. No.: US 2025/0048030 A1
(43) Pub. Date: Feb. 6, 2025

(54) AUDIO DATA PROCESSING METHOD AND APPARATUS

(71) Applicant: Lenovo (Beijing) Limited, Beijing (CN)

(72) Inventors: Jing ZHAO, Beijing (CN); Xuguo LIU, Beijing (CN)

(21) Appl. No.: 18/790,826

(22) Filed: Jul. 31, 2024

(30) Foreign Application Priority Data
Jul. 31, 2023 (CN) 202310953214.X

(51) Int. Cl. H04R 3/12; G06F 3/16; H04M 1/72412; H04M 1/72454

(52) U.S. Cl. CPC H04R 3/12; G06F 3/162; H04M 1/72412; H04M 1/72454; H04R 2420/07

(57) ABSTRACT

An audio data processing method includes determining that a first electronic device is in a first mode, obtaining first audio data based on a wireless communication module of the first electronic device, transmitting the first audio data to a virtual module of the first electronic device, and sending, by the virtual module, the first audio data to a second electronic device. The virtual module communicates with the wireless communication module by simulating compliance with a target communication protocol. In response to the first electronic device being in a second mode, the first audio data is sent to a third electronic device for playback through the wireless communication module. The third electronic device communicates with the wireless communication module following the target communication protocol.

### CROSS-REFERENCE TO RELATED APPLICATION

The present disclosure claims priority to Chinese Patent Application No. 202310953214.X, filed on Jul. 31, 2023, the entire content of which is incorporated herein by reference.

### TECHNICAL FIELD

The present disclosure relates to the communication technology field and, more particularly, to an audio data processing method and an audio data processing device.

### BACKGROUND

Currently, electronic devices are able to transmit local audio data to other electronic devices to be played. For example, a wireless connection channel is established between a plurality of electronic devices by using wireless interconnection technology. Based on this, the plurality of electronic devices transmit audio data via the wireless connection channel. Thus, the local audio data of the electronic devices are played on other electronic devices.

However, in some special scenarios, such as when an electronic device is in a voice call, the electronic device cannot transmit the audio data of the voice call to other electronic devices. Thus, the other electronic devices cannot be used to play the audio of the voice call.

### SUMMARY

According to a first aspect of the present invention, there is provided an audio data processing method. The method includes determining that a first electronic device is in a first mode, obtaining first audio data based on a wireless communication module of the first electronic device, transmitting the first audio data to a virtual module of the first electronic device, and sending, by the virtual module, the first audio data to a second electronic device. The virtual module communicates with the wireless communication module by simulating compliance with a target communication protocol. In response to the first electronic device being in a second mode, the first audio data is sent to a third electronic device for playback through the wireless communication module. The third electronic device communicates with the wireless communication module following the target communication protocol.

According to a second aspect of the present invention, there is provided an audio data processing apparatus, including a data acquisition unit, a first data transmission unit, and a data sending unit. The data acquisition unit is configured to determine that a first electronic device is in a first mode, and obtain first audio data based on a wireless communication module of the first electronic device. The first data transmission unit is configured to transmit the first audio data to a virtual module of the first electronic device. The virtual module communicates with the wireless communication module by simulating compliance with a target communication protocol. The data-sending unit is configured to send, through the virtual module, the first audio data to a second electronic device. In response to the first electronic device being in a second mode, the first audio data is sent to a third electronic device for playback through the wireless communication module. The third electronic device communicates with the wireless communication module following the target communication protocol.

According to a second aspect of the present invention, there is provided an electronic device with a computer-readable storage medium storing one or more computer programs that, when executed by one or more processors, the one or more computer programs perform an audio data processing method. The method includes determining that a first electronic device is in a first mode, obtaining first audio data based on a wireless communication module of the first electronic device, transmitting the first audio data to a virtual module of the first electronic device, and sending, by the virtual module, the first audio data to a second electronic device. The virtual module communicates with the wireless communication module by simulating compliance with a target communication protocol. In response to the first electronic device being in a second mode, the first audio data is sent to a third electronic device for playback through the wireless communication module. The third electronic device communicates with the wireless communication module following the target communication protocol.

### BRIEF DESCRIPTION OF THE DRAWINGS

FIG. 1 illustrates a schematic flowchart of an audio data processing method according to some embodiments of the present disclosure.

FIG. 2 illustrates a schematic flowchart of another audio data processing method according to some embodiments of the present disclosure.

FIG. 3 illustrates a schematic diagram showing a transmission frame of audio data in a first electronic device according to some embodiments of the present disclosure.

FIG. 4 illustrates a schematic architectural diagram of a solution in an application scene according to some embodiments of the present disclosure.

FIG. 5 illustrates a schematic flowchart of an audio data processing method in an application scenario according to some embodiments of the present disclosure.

FIG. 6 illustrates a schematic structural diagram of an audio data processing device according to some embodiments of the present disclosure.

FIG. 7 illustrates a schematic structural diagram of an electronic device according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Obviously, described embodiments are merely some embodiments of the present disclosure, not all embodiments. Based on embodiments of the present disclosure, all other embodiments obtained by those ordinary skills in the art without any creative effort are within the scope of the present disclosure.

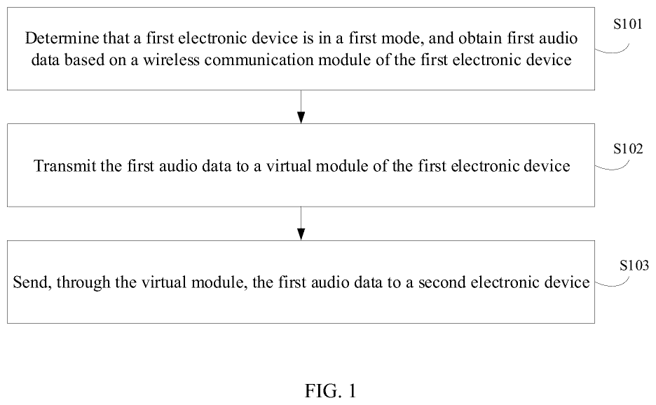

FIG. 1 illustrates a schematic flowchart of an audio data processing method according to some embodiments of the present disclosure. The method of embodiments of the present disclosure can be applied to a first electronic device. The first electronic device can include a cell phone, a tablet, or a laptop, which is not limited.

The method of embodiments of the present disclosure includes the following processes.

At S101, the first electronic device is determined to be in a first mode, and first audio data is obtained based on a wireless communication module of the first electronic device. The first mode can be used to indicate that the first electronic device needs to use a second electronic device to broadcast the audio data that is to be broadcasted by the first electronic device.

For example, the first electronic device being in the first mode can include a wireless interconnection channel being established between the first electronic device and the second electronic device. The wireless interconnection channel can be a wireless direct connection channel established between the electronic devices based on the wireless interconnection technology. Based on the wireless interconnection channel between the electronic devices, the data can be effectively and safely transmitted between the electronic devices.

For another example, the first electronic device being in the first mode can include the first electronic device being in a mode of using the second electronic device to play the audio. For example, a wireless connection can be established between the first electronic device and the second electronic device. The second electronic device can be configured in the first electronic device as the audio playback device of the first electronic device.

The wireless communication module can be a module supporting the wireless communication of the electronic device. In the present disclosure, the communication protocol used in the wireless communication module can be a target communication protocol. For example, the wireless communication module can be a Bluetooth module. The wireless communication module can support the Bluetooth communication protocol. Of course, the wireless communication module can also be a WiFi module. Correspondingly, the wireless communication module can support the WiFi communication protocol, which is not limited.

The first audio data can be the audio data that the first electronic device needs to play. For example, the first audio data can be the to-be-played audio data stored in the first electronic device, or the audio data that needs to be played received by the first electronic device that needs to be played, which is not limited.

At S102, the first audio data is transmitted to a virtual module of the first electronic device.

The virtual module simulates communication with the wireless communication module following the target communication protocol.

In the present disclosure, the virtual module can be a module simulated in the first electronic device that follows the target communication protocol and communicates with the wireless communication module of the first electronic device. Based on this, with the communication and interaction between the simulated virtual module and the wireless communication module, the communication effect between the wireless communication module of the first electronic device and the device or module that is accessed to the first electronic device and follows the target communication protocol.

Before step S201, the connection between the virtual module and the wireless communication module can also be established. For example, in some embodiments, the first electronic device can assign an address identifier for the virtual module after the virtual module is simulated. Based on this, the first electronic device can determine the address identifier of the virtual module. Correspondingly, based on the address identifier of the virtual module, the connection between the virtual module and the wireless communication module can be established.

When the virtual module is connected to the wireless communication module, the wireless communication module can proactively send the obtained first audio data to the virtual module.

For example, When the wireless communication module is a Bluetooth module, the constructed virtual module can be a virtual Bluetooth headset configured to simulate a Bluetooth headset, or a virtual Bluetooth communication device configured to simulate a Bluetooth receiver or transceiver. Accordingly, after the virtual Bluetooth headset or virtual Bluetooth communication device establishes a connection with the Bluetooth module of the first electronic device, the Bluetooth module can send the obtained first audio data to the virtual Bluetooth headset or virtual Bluetooth communication device.

At S103, the first audio data is sent to the second electronic device through the virtual module.

For example, when a wireless interconnection channel is established between the first electronic device and the second electronic device, the first audio data can be sent to the second electronic device through the wireless interconnection channel by the virtual module.

For example, based on the communication address of the second electronic device, the first audio data can be sent to the second electronic device by the virtual module.

In the present disclosure, the first electronic device also includes a second mode. If the first electronic device is in the second mode, the first audio data can be sent to a third electronic device for playback by the wireless communication module. The third electronic device and the wireless communication module can communicate by following the target communication protocol.

For example, when the first electronic device is in the second mode, the first electronic device can establish a connection with the third electronic device outside the first electronic device by the wireless communication module following the target communication protocol. Thus, the first electronic device can send the first audio data directly to the third electronic device that supports the target communication protocol through the wireless communication module.

For example, if the wireless communication module is a Bluetooth module, the third electronic device can be a Bluetooth headset. Based on this, the first electronic device can establish a wireless Bluetooth connection channel with the Bluetooth headset based on the Bluetooth module. Correspondingly, the first electronic device can transmit the audio data that needs to be played to the Bluetooth headset through the Bluetooth connection channel via the Bluetooth module.

The situation is similar when the wireless communication module is another type of wireless communication module, which is repeated.

Based on the above, in embodiments of the present disclosure, the virtual module that follows the target communication protocol can be simulated in the first electronic device. Thus, the virtual device accessing the first electronic device can be simulated. The virtual device can communicate with the wireless communication module using the target communication protocol. Based on this, when the first electronic device is in the first mode, and after the electronic device obtains the first audio data through the wireless communication module, the first audio data can be transmitted to the virtual module. Thus, the virtual module can obtain the to-be-played audio data when the first electronic device is in different application scenes and send the audio data to the second electronic device through the virtual module. The situation that the audio data that needs to be played by the first electronic device cannot be synchronized to be played on the second electronic device during a phone call can be reduced.

The virtual module can be the module simulated in the first electronic device that follows the target communication protocol. Based on this, the communication between the virtual module and the wireless communication module can differ from the communication between the wireless communication module and an actual external device that follows the target communication protocol. For example, the connection method required for the communication between the wireless communication module and the virtual module can differ from the wireless connection established between the wireless communication module and the third electronic device following the target communication protocol.

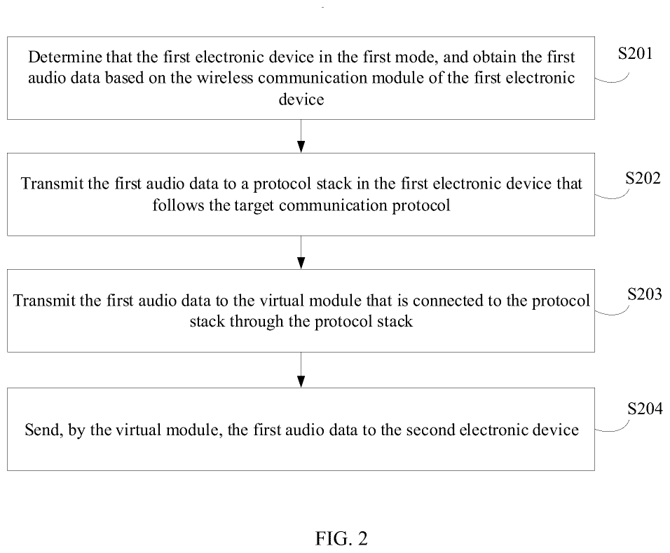

For example, FIG. 2 illustrates a schematic flowchart of another audio data processing method according to some embodiments of the present disclosure. The method of the present disclosure includes the following processes.

At S201, the first electronic device is determined to be in the first mode, and the first audio data is obtained based on the wireless communication module of the first electronic device.

At S202, the first audio data is transmitted to a protocol stack in the first electronic device that follows the target communication protocol.

The protocol stack can be a software program in the first electronic device that follows the target communication protocol and implements the target communication protocol.

For example, when the wireless communication module is a Bluetooth module, the target communication protocol can be the Bluetooth communication protocol. Accordingly, the protocol stack can be a Bluetooth protocol stack.

At S203, the first audio data is transmitted to the virtual module that is connected to the protocol stack through the protocol stack.

The protocol stack can be configured to connect the wireless communication module and an application that is developed based on the protocol stack. Based on this, the virtual module that accesses the protocol stack can be simulated in the first electronic device. Thus, the virtual module can communicate with the wireless communication module through the protocol stack. Correspondingly, the wireless communication module can also communicate with the virtual module that is accessed to the protocol stack through the protocol stack, Thus, the wireless communication module can transmit the first audio data to the virtual module via the protocol stack.

For example, when the first electronic device includes a simulated virtual module, related information of the wireless module can be configured in the protocol stack. For example, the address identifier of the virtual module can be configured in the protocol stack to cause the virtual module to access the protocol stack.

Of course, the present disclosure may not limit the specific implementation of the virtual module accessing the protocol stack, which is not repeated.

In embodiments of the present disclosure, before the wireless communication module sends the first audio data to the virtual module, the virtual module can establish the connection with the wireless communication module through the protocol stack.

The process of the virtual module establishing the connection with the wireless communication module through the protocol stack can be used to simulate the process of the physical device that follows the target communication protocol establishing the connection with the wireless communication module. Thus, a special connection can be established between the virtual module and the wireless communication module through the protocol stack.

Considering the difference between the virtual module and the physical device following the target communication protocol, it is difficult to find the virtual module proactively through the wireless communication module. Based on this, the first electronic device can simulate that the virtual module has been found and instruct the wireless communication module to establish the connection with the virtual module.

The process of establishing the connection between the virtual module and the wireless communication module via the protocol stack can simulate the process of establishing a connection between a physical device following the target communication protocol and the wireless communication module so that a special connection can be established between the virtual module and the wireless communication module via the protocol stack.

For example, in some embodiments, the first electronic device can send a device connection instruction to the operating system. The device connection instruction can be used to instruct the wireless communication module to establish a connection with the virtual module. The connection instruction can include the address identifier of the virtual module. Correspondingly, the operating system can send the address identifier of the virtual module to the wireless communication module. Based on this, the wireless communication module can establish the connection with the virtual module through the protocol stack based on the address identifier of the virtual module.

By simulating the virtual module accessing the protocol stack, with the protocol stack, the connection between the virtual module and the wireless communication module can be realized via the protocol stack. Thus, reliable data communication can be realized between the virtual module and the wireless communication module.

At S204, the virtual module sends the first audio data to the second electronic device.

Step S204 can refer to the related description above and is not repeated here.

The communication and connection between the virtual module and the wireless communication module of the present disclosure can be different from the connection and the communication between the wireless communication module and the physical device following the target communication protocol. For example, if the second electronic device is in the second mode, the first audio data can be sent to the third electronic device through the wireless communication module and the protocol stack via the target wireless communication connection. The target wireless communication connection can be the wireless connection established between the first electronic device and the third electronic device based on the target communication protocol.

For example, based on the above, the wireless communication module can be a Bluetooth module. The third electronic device can include a Bluetooth headset. The target wireless communication connection can be the wireless Bluetooth connection channel established between the Bluetooth module and the Bluetooth headset.

In the present disclosure, the first audio data obtained by the wireless communication module of the first electronic device can be the audio data that needs to be played locally by the first electronic device or the audio data received by the first electronic device that needs to be played locally, which is not limited.

For example, in some embodiments, the wireless communication module obtaining the first audio data can include at least one of obtaining the first audio data that needs to be played by the audio output application based on the wireless communication module of the first electronic device or obtaining the first audio data that needs to be played in the voice call application based on the wireless communication module of the first electronic device.

The audio output application of the first electronic device can be various applications that can output audio on the first electronic device. For example, the audio output application can include an audio player, a video player, a browser supporting audio playback, or other types of applications, which is not limited.

In the present disclosure, the first electronic device can be in the first mode. The to-be-played first audio data of the audio output application and the voice call application can be transmitted to the wireless communication module. Thus, the first audio data can be sent to the virtual module by the wireless communication module to cause the virtual module to transmit the to-be-output audio data of the audio output application of the first electronic device and the to-be-played voice data in the voice communication (also referred to as voice call) state to the second electronic device.

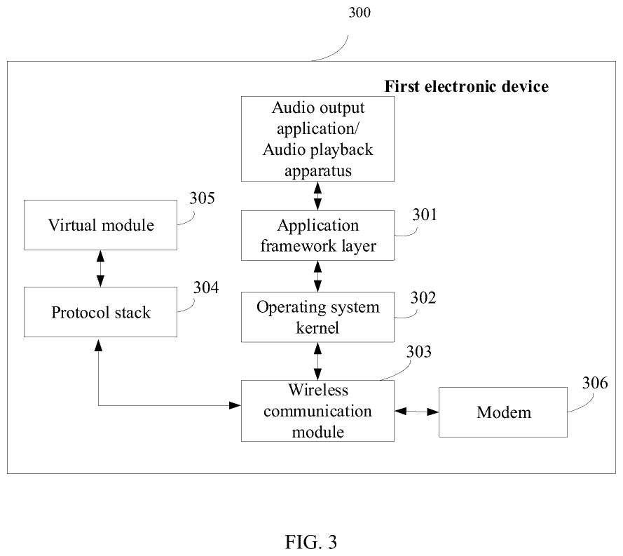

In some embodiments, when the first electronic device is in the first mode, the first electronic device can automatically configure the transmission path of the audio data to be directed to the wireless communication module. To facilitate understanding, a description is made in connection with FIG. 3.

As shown in FIG. 3, when the audio output application of a first electronic device 300 includes the to-be-played first audio data, the first audio data is transmitted to an application framework layer 301 of the operating system, and then transmitted to an operating system kernel 302 through the application framework layer 301. In some embodiments, when the wireless communication module is not connected to the third electronic device, the kernel of the operating system can output the first audio data to an audio playback apparatus such as a speaker for playback.

However, in the present disclosure, when the first electronic device 300 is in the first mode, the first electronic device can configure a transmission path of the first audio data from the audio output application. After the operating system kernel 302 obtains the first audio data from the audio output application, the first audio data can be transmitted to the wireless communication module 303. As shown in FIG. 3, after the application framework layer 301 obtains the to-be-played first audio data of the audio output application, the application framework layer 301 transmits the first audio data to the operating system kernel 302. The operating system kernel 302 transmits the first audio data to the wireless communication module 303.

Based on this, the wireless communication module 303 can send the first audio data to the virtual module 305 via the protocol stack 304. The first audio data can be sent to the second electronic device through the virtual module.

On another hand, when the user uses the first electronic device to perform a voice call, such as making a phone call, or initiating or receiving a voice call via an instant messaging application, the audio data collected by the audio collection apparatus in the first electronic device and the audio data sent by the other end of the voice call received by the first electronic device can be transmitted to the voice communication processing module of the first electronic device. As shown in FIG. 3, for example, the voice communication processing module is a modem 306. Based on this, the audio data sent by the other end of the voice call obtained by the modem can be the to-be-played first audio data by the voice call application.

In the present disclosure, when the virtual module is simulated in the first electronic device, for example, when the virtual module establishes the connection with the wireless communication module, the first electronic device can transmit the to-be-played audio data obtained by the modem to the wireless communication module. As shown in FIG. 3, the modem 306 can exchange data with the wireless communication module 303. Based on this, the wireless communication module 303 can obtain the to-be-played first audio data transmitted by the modem 306 and belonging to the voice call application.

Correspondingly, the wireless communication module 303 can transmit the first audio data to the virtual module 305 via the protocol stack 304.

To facilitate understanding, an application scenario is taken as an example for description. For example, the wireless interconnection channel can be established between the first electronic device and at least one second electronic device.

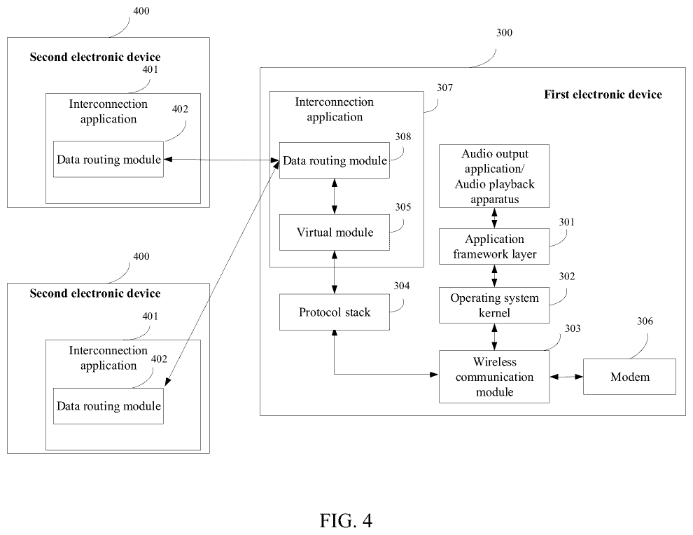

FIG. 4 illustrates a schematic architectural diagram of a solution in an application scenario according to some embodiments of the present disclosure.

As shown in FIG. 4, an interconnection application 307 is installed in the first electronic device 300. An interconnection application 401 is also installed in the second electronic device 400. The wireless interconnection channel can be established between the first electronic device and the second electronic device with the interconnection applications of the first electronic device and the second electronic device. The processes and the implementation of establishing the wireless interconnection are not limited.

Based on this, the virtual module that follows the target communication protocol can be simulated in the interconnection application of the first electronic device. The interconnection applications of the first electronic device and the second electronic device each can include a data routing module. The data routing module can realize the wireless interconnection between different electronic devices. As shown in FIG. 4, the interconnection application 401 of the second electronic device 400 includes a data routing module 402.

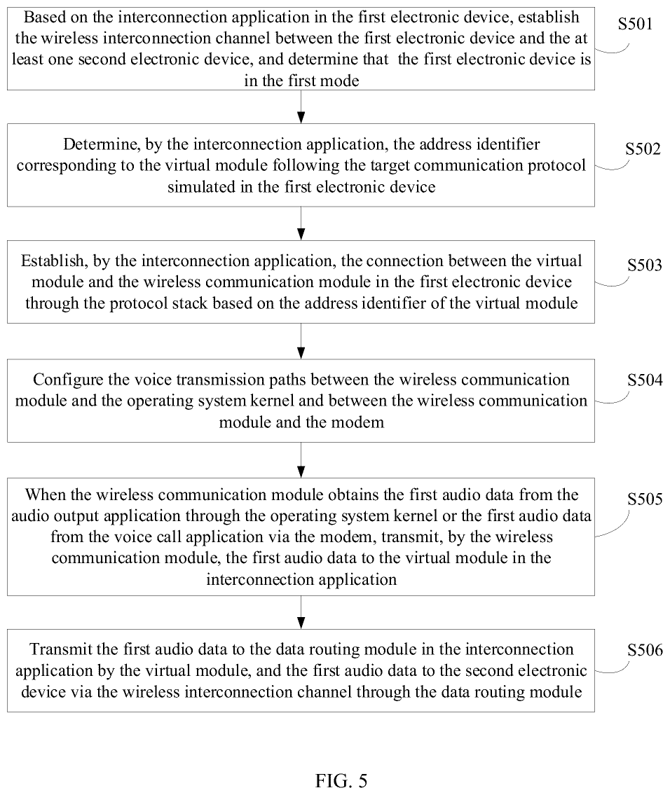

In connection with the application scenario architecture in FIG. 4, the description is made by taking an embodiment as an example. FIG. 5 illustrates a schematic flowchart of an audio data processing method in an application scenario according to some embodiments of the present disclosure. The method of embodiments of the present disclosure can include the following processes.

At S501, based on the interconnection application in the first electronic device, the wireless interconnection channel is established between the first electronic device and the at least one second electronic device, and the first electronic device is determined to be in the first mode.

When the wireless interconnection channel is established between the first electronic device and the second electronic device, the first electronic device and the second electronic device can mutually transmit data.

For example, the first electronic device can be used as a host device, which can transmit the audio or video data of the first electronic device to the second electronic device through the wireless interconnection channel. Thus, the corresponding video data can be played by the second electronic device. Of course, the first electronic device can be used as a controlled device to have the audio data to be played by the second electronic device, which is not limited.

In some embodiments, when the wireless interconnection channel is established between the first electronic device and the second electronic device, the first electronic device can be determined to be in the first mode after the target operation instruction is detected. The target operation instruction can be used to instruct to transmit the to-be-played audio data in the first electronic device to the target second electronic device. The target second electronic device can be one of the at least one second electronic device for establishing the wireless interconnection channel.

At S502, the interconnection application determines the address identifier corresponding to the virtual module following the target communication protocol simulated in the first electronic device.

The virtual module is accessed to the protocol stack in the first electronic device that follows the target communication protocol.

At S503, the interconnection application establishes the connection between the virtual module and the wireless communication module in the first electronic device through the protocol stack based on the address identifier of the virtual module.

The wireless communication module can support communication based on the target communication protocol.

For steps S502 and S503, reference can be made to the above description, which is not repeated here.

For example, the virtual module can be a virtual Bluetooth headset that follows the Bluetooth protocol (similar to other types of virtual Bluetooth modules). The interconnection application can send a Bluetooth discovery indication to the operating system of the first electronic device. The Bluetooth discovery indication can be used to indicate that the discovered Bluetooth device that needs to be connected is the virtual Bluetooth headset. The Bluetooth discovery indication can carry the address identifier of the virtual Bluetooth headset.

Based on this, the operating system can send the Bluetooth discovery indication to the Bluetooth module in the first electronic device. The Bluetooth module can send a connection indication to the protocol stack based on the address identifier of the Bluetooth headset. The protocol stack can determine that the device to be connected is the virtual Bluetooth headset based on the address identifier and establish the connection between the virtual Bluetooth headset and the Bluetooth module.

At S504, the voice transmission paths between the wireless communication module and the operating system kernel and between the wireless communication module and the modem are configured.

For example, after the operating system confirms that the virtual module establishes the connection with the wireless communication module, the audio data from the application framework layer to the operating system kernel can be transmitted to the wireless communication module. Correspondingly, the audio data of the modem can be transmitted to the wireless communication module, which is described according to the description of FIG. 3 and is not repeated here.

For example, the virtual module simulated in the first electronic device can be a virtual Bluetooth headset. After the connection is established between the virtual Bluetooth headset and the Bluetooth module, the operating system of the first electronic device can consider that a real Bluetooth headset is externally connected to the first electronic device. Thus, the operating system can configured to transmit the to-be-played audio data to the Bluetooth module. Thus, the audio data can be output to the simulated virtual Bluetooth headset through the Bluetooth module.

At S505, when the wireless communication module obtains the first audio data from the audio output application through the operating system kernel or the first audio data from the voice call application via the modem, the wireless communication module transmits the first audio data to the virtual module in the interconnection application.

At S506, the first audio data is transmitted to the data routing module in the interconnection application by the virtual module, and the first audio data is transmitted to the second electronic device via the wireless interconnection channel through the data routing module.

Of course, FIG. 4 and FIG. 5 are merely examples of an application scenario. If a wireless interconnection channel is not been established between the first electronic device and the second electronic device, but data transmission can be achieved by other methods, when the first electronic device is in the first mode, related processes of embodiments of the present disclosure are also suitable for other scenarios, which is not repeated.

Each communication protocol can involve a plurality of sub-protocols. To improve the transmission efficiency and audio quality of the audio data, processing can be performed using different sub-protocols for different types of audio data.

Based on this, in the present disclosure, the virtual module can also be configured with at least two sub-protocols. If the first audio data comes from an audio output application, the virtual module can use the first sub-protocol under the target communication protocol to process the first audio data and then send the processed first audio data to the second electronic device.

Similarly, if the first audio data comes from a voice call application, the virtual module can use the second sub-protocol under the target communication protocol to process the first audio data and then send the processed first audio data to the second electronic device.

The audio data processed by the first sub-protocol can have better quality than the audio data processed by the second sub-protocol.

Processing the audio data using the first sub-protocol and the second sub-protocol can include decoding the audio data. In some embodiments, the virtual Bluetooth module can also support encoding the audio data based on these two types of data.

For example, the target communication protocol can be the Bluetooth communication protocol, and the virtual module can be a virtual Bluetooth headset. The first sub-protocol can be an Advanced Audio Distribution Profile (A2DP), which can be also referred to as the Bluetooth audio transmission protocol. The second sub-protocol can be the Bluetooth Hands-Free Profile (HFP).

For example, the above first electronic device can be in the first mode, and the to-be-played first audio data of the first electronic device can be obtained by the wireless communication module and transmitted to the virtual module. In practical applications, considering that the electronic device is currently in the voice call state. The first electronic device cannot transmit the audio data sent by the other end of the voice call in the voice call to other electronic devices. Based on this, if the voice call of the first electronic device is in the audio communication state, the first audio data can be obtained based on the wireless communication module of the first electronic device of the present disclosure.

For example, when the voice call of the first electronic device is in the audio communication state, the first electronic device can start the virtual module, or establish the connection between the virtual module and the wireless communication module. Based on this, the wireless communication module can obtain the first audio data transmitted to the wireless communication module by the audio communication processing module such as the modem based on the above-related description.

Further, if the voice call application of the first electronic device is not in the voice call communication state, the second audio data can be obtained based on the operating system of the electronic device. The second audio data can be transmitted to the second electronic device. The second audio data can be the to-be-played audio data of the audio output application.

For example, when the voice call application of the first electronic device is not in the voice communication state, the first electronic device may not start the virtual module or may not establish the connection between the virtual module and the wireless communication module. Based on this, after the first electronic device obtains the audio data through the application framework layer, and after the audio data is transmitted to the operating system kernel, since the audio data obtained by the operating system can be transmitted to other electronic device by the first electronic device, the audio data can be directly transmitted to the second electronic device without through the wireless communication module.

For example, as shown in FIG. 4, the voice call of the first electronic device 300 is not in the voice communication state. The to-be-played audio data of the audio output application can be transmitted to the operating system kernel 302 through the application framework layer 301. The operating system kernel 302 can then directly transmit the audio data to the interconnection application 307. The interconnection application 307 can further transmit the data to the second electronic device through the data routing module.

The first electronic device can also obtain the audio data sent by the second electronic device. To facilitate distinction, the audio data from the second electronic device received by the first electronic device can be referred to as the third audio data. Based on this, the virtual module can also transmit the third audio data to the wireless communication module. Correspondingly, the first electronic device can output the third audio data obtained by the wireless communication module.

A plurality of resources of the audio data obtained by the wireless communication module can be provided. A plurality of target applications of the third audio data can be provided.

For example, if the target application of the third audio data is the voice output application of the first electronic device, the third audio data can be sent to the voice communication processing module of the first electronic device and output through the voice communication processing module.

If the target application of the third audio data is the audio output application of the first electronic device, the third audio data can be output to the audio playback apparatus through the operating system.

The voice communication processing module can be a modem or a module responsible for receiving and transmitting voice signals in the voice communication state.

As shown in FIG. 3 or FIG. 4, for example, the audio communication processing module is a modem. After the virtual module 305 of the first electronic device 300 obtains the third audio data sent by the second electronic device 400, the virtual module 305 transmits the third audio data to the wireless communication module 303 via the protocol stack 304. The wireless communication module 305 determines that the target application of the third audio data is the voice call application. Then, the wireless communication module 303 transmits the third audio data to the modem 306. Then, the modem 306 processes and sends the third audio data to the other end of the voice call.

The audio playback apparatus can be a speaker or other apparatuses configured to play video and audio. Similarly, as shown in FIG. 3 or FIG. 4, after the virtual module 305 of the first electronic device 300 transmits the third audio data to the wireless communication module 303 via the protocol stack 304, the wireless communication module 303 can determine that the target application of the third audio data is the audio output application. Then, the wireless communication module 303 can transmit the third audio data to the operating system kernel 302. Then, the operating system kernel 302 can transmit the third audio data to the application framework layer 301, and the third audio data can be broadcast by the audio playback apparatus.

Corresponding to an audio data processing method of the present disclosure, the present disclosure further provides an audio data processing apparatus.

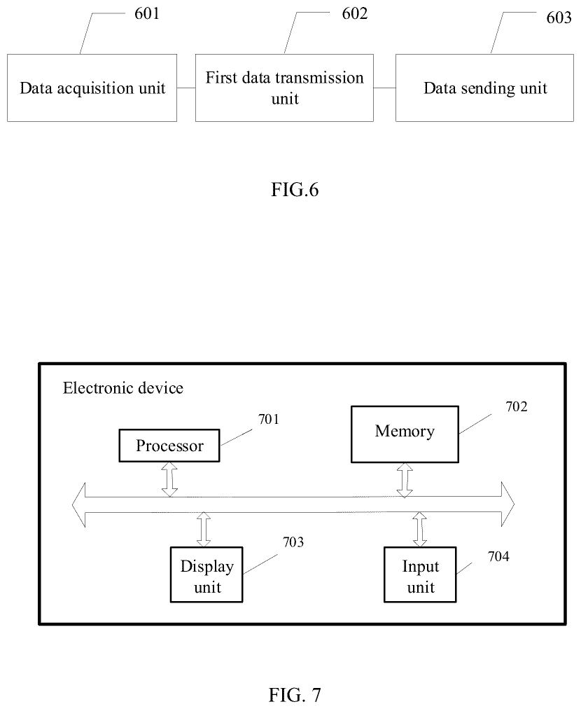

FIG. 6 illustrates a schematic structural diagram of an audio data processing apparatus according to some embodiments of the present disclosure. The apparatus can be applied to the first electronic device. The apparatus includes a data acquisition unit 601, a first data transmission unit 602, and a data transmission unit 603.

The data acquisition unit 601 can be configured to determine that the first electronic device is in the first mode and obtain the first audio data based on the wireless communication module of the first electronic device.

The first data transmission unit 602 can be configured to transmit the first audio data to the virtual module of the first electronic device. The virtual module can be simulated to communicate with the wireless communication module by following the target communication protocol. The data transmission unit 603 can be configured to send the first audio data to the second electronic device through the virtual module.

If the first electronic device is in the second mode, the first audio data can be sent to the third electronic device for playback via the wireless communication module. The third electronic device can communicate with the wireless communication module by following the target communication protocol.

For example, the first electronic device can include a special mode unit. The special mode unit can be configured to, if the first electronic device is in the second mode, the first audio data can be sent to the third electronic device for playback through the wireless communication model. The third electronic device can communicate with the wireless communication module by following the target communication protocol.

In some embodiments, the first data transmission unit includes a first transmission sub-unit and a second transmission sub-unit.

The first transmission sub-unit can be configured to transmit the first audio data to the protocol stack in the first electronic device that follows the target communication protocol.

The second transmission sub-unit can be configured to transmit the first audio data to the virtual module accessing the protocol stack via the protocol stack.

If the second electronic device is in the second mode, the first audio data can be sent to the third electronic device through the wireless communication module and the protocol stack, and through the target wireless communication connection. The target wireless communication connection can be a wireless connection established between the first electronic device and the third electronic device based on the target communication protocol.

In some embodiments, the apparatus can further include an identification determination unit and a connection establishment unit.

The identification determination unit can be configured to determine the address identifier of the virtual module.

The connection establishment unit can be configured to establish a connection between the virtual module and the wireless communication module based on the address identifier of the virtual module.

In some other embodiments, the data acquisition unit can include a data acquisition sub-unit.

The data acquisition sub-unit can be configured to determine that the first electronic device is in the first mode. If the voice call application of the first acquisition sub-unit is in the voice call state, the first audio data can be obtained based on the wireless communication module of the first electronic device.

In some embodiments, the apparatus can also include a data direct transmission unit.

The data direct transmission unit can be configured to, if the voice call application of the first electronic device is not in the voice call communication state, the second audio data can be obtained based on the operating system of the electronic device, and sent to the second electronic device.

In some other embodiments, the data acquisition unit obtaining the first audio data based on the wireless communication module of the first electronic device can include at least one of obtaining the first audio data that needs to be played by the audio output application based on the wireless communication module of the first electronic device or obtaining the first audio data that needs to be played in the voice call application based on the wireless communication module of the first electronic device.

Further, the first data transmission unit can include a first transmission processing sub-unit and a second transmission processing sub-unit.

The first transmission processing sub-unit can be configured to, if the first audio data is from the audio application output, process the first audio data when the virtual module adopts the first sub-protocol of the target communication protocol, and transmit the processed first audio data to the second electronic device.

The second sending processing sub-unit can be configured to, if the first audio data is from the voice call application, process the first audio data when the virtual model adopts the second sub-protocol of the target communication protocol and send the processed first audio data to the second electronic device.

In some other embodiments, the apparatus can also include a data reception unit and a second data transmission unit, and a data output unit.

The data reception unit can be configured to obtain the third audio data sent by the second electronic device.

The second data transmission unit can be configured to transmit the third audio data to the wireless communication module through the virtual module.

The data output unit can be configured to output the third audio data obtained by the wireless communication module.

In some embodiments, the data output unit can include a first data output unit and a second data output unit.

The first data output sub-unit can be configured to, if the target application of the third audio data is the audio communication application of the first electronic device, transmit the third audio data to the voice communication processing module of the first electronic device and output the third audio data through the voice communication processing module.

The second data output sub-unit can be configured to, if the target application of the third audio data is the audio output application of the first electronic device, output the third audio data to the audio playback apparatus through the operating system.

On another aspect, the present disclosure further provides an electronic device. FIG. 7 illustrates a schematic structural diagram of the electronic device according to some embodiments of the present disclosure. The electronic device can be any type of electronic device. The electronic device can include at least one or more processors 701 and one or more memories 702.

The one or more processors 701 can be configured to perform the audio data processing method of any one of embodiments of the present disclosure.

The one or more memories can be used to store a program needed for the one or more processors to perform the operation.

The electronic device can further include a display unit 703 and an input unit 704.

The electronic device can include more or less components of FIG. 7, which is not limited.

On another aspect, the present disclosure further provides a computer-readable storage medium. The computer-readable storage medium can store at least one instruction, at least a segment of a program, code sets, or an instruction set. The at least one instruction, the at least one segment of the program, the code set, or the instruction set can be loaded by the one or more processors and performed to realize the audio data processing method of any one embodiment.

On another aspect, the present disclosure further includes a computer program. The computer code can include a computer instruction. The computer instruction can be stored in the computer-readable storage medium. When the computer program runs on the electronic device, the one or more processors can be configured to perform the audio data processing method of any one of embodiments of the present disclosure.

In the present disclosure, the terms such as “first,” “second,” “third,” “fourth,” etc. in the specification, claims, and the accompanying drawings (if any) are used to distinguish similar parts and are not necessarily used to describe a specific sequence or order. The data described here can be interchangeably used where appropriate so that embodiments of the present disclosure described here can be implemented in a sequence other than that shown in the figures.

Each embodiment described in this specification is described in a progressive manner. Each embodiment focuses on the differences from other embodiments. Similar parts between different embodiments can refer to each other. Meanwhile, features described in various embodiments can be substituted or combined with each other to enable those skilled in the art to implement or use the present disclosure. Since device embodiments are fundamentally similar to method embodiments, the description of the device embodiments can be simple. The relevant aspects can refer to the description of method embodiments.

In the specification, relational terms such as “first” and “second” are used merely to distinguish one entity or operation from another, without necessarily implying any actual relationship or order between these entities or operations. Additionally, terms like “comprise,” “include,” or any other variants thereof are intended to cover non-exclusive inclusion, such that a process, method, article, or device comprising a series of elements includes not only those elements explicitly listed, but also other elements inherent to such process, method, article, or device. Unless specified otherwise, the term “comprising a . . . ” does not exclude the presence of additional identical elements in the process, method, article, or device including the said elements.

The above descriptions of disclosed embodiments can enable those skilled in the art to implement or use the present disclosure. Various modifications to these embodiments are apparent to those skilled in the art, and the general principles defined herein may be applied to other embodiments without departing from the spirit or scope of the present disclosure. Therefore, the scope of the present disclosure is not limited to the embodiments shown here but is defined by the widest scope consistent with the principles and novel features disclosed here.

The above are merely some embodiments of the present disclosure. For those ordinary skills in the art, improvements and modifications can be made without departing from the principles of the present disclosure. The improvements and modifications are also within the scope of the present disclosure.

What is claimed is:

1. An audio data processing method comprising:
determining that a first electronic device is in a first mode, and obtaining first audio data based on a wireless communication module of the first electronic device;
transmitting the first audio data to a virtual module of the first electronic device, the virtual module communicating with the wireless communication module by simulating compliance with a target communication protocol; and
sending, by the virtual module, the first audio data to a second electronic device;
wherein:
in response to the first electronic device being in a second mode, the first audio data is sent to a third electronic device for playback through the wireless communication module; and
the third electronic device communicates with the wireless communication module following the target communication protocol.

2. The method of claim 1, wherein transmitting the first audio data to the virtual module of the first electronic device includes:
transmitting the first audio data to a protocol stack of the first electronic device following the target communication protocol; and
transmitting the first audio data to the virtual module accessing the protocol stack through the protocol stack;
wherein:
in response to the second electronic device being in a second mode, the first audio data is sent to the third electronic device via the protocol stack and the wireless communication module and through a target wireless communication connection; and
the target wireless communication connection is a wireless connection established between the first electronic device and the third electronic device based on the target communication protocol.

3. The method of claim 1, further comprising:
determining an address identifier of the virtual module; and
establishing a connection between the virtual module and the wireless communication module based on the address identifier of the virtual module.

4. The method of claim 1, wherein obtaining the first audio data based on the wireless communication module of the first electronic device includes:
in response to a voice call application of the first electronic device being in a voice communication state, obtaining the first audio data based on the wireless communication module of the first electronic device.

5. The method of claim 4, further comprising:
in response to the voice call application of the first electronic device being not in a voice communication state, obtaining second audio data from an operating system of the first electronic device and transmitting the second audio data to the second electronic device.

6. The method of claim 1, wherein obtaining the first audio data based on the wireless communication module of the first electronic device includes at least one of:
obtaining the first audio data required for playback by an audio output application based on the wireless communication module of the first electronic device; or
obtaining the first audio data required for playback by a voice call application based on the wireless communication module of the first electronic device.

7. The method of claim 6, wherein sending, by the virtual module, the first audio data to the second electronic device includes:
in response to the first audio data being from the audio output application, processing the first audio data by the virtual module using a first sub-protocol of the target communication protocol and sending the processed first audio data to the second electronic device; and
in response to the first audio data being from the voice call application, processing the first audio data by the virtual module using a second sub-protocol of the target communication protocol and sending the processed first audio data to the second electronic device.

8. The method of claim 1, further comprising:
obtaining third audio data sent by the second electronic device;
transmitting the third audio data to the wireless communication module through the virtual module; and
outputting the third audio data obtained by the wireless communication module.

9. The method of claim 8, wherein outputting the third audio data obtained by the wireless communication module includes:
in response to a target application of the third audio data being the voice communication application of the first electronic device, sending the third audio data to a voice communication processing module of the first electronic device, and outputting the third audio data through the voice communication processing module;
in response to the target application of the third audio data being the audio output application of the first electronic device, outputting the third audio data to an audio playback apparatus through the operating system.

10. An audio data processing apparatus comprising:
a data acquisition unit configured to determine that a first electronic device is in a first mode, and obtain first audio data based on a wireless communication module of the first electronic device;
a first data transmission unit configured to transmit the first audio data to a virtual module of the first electronic device, the virtual module communicating with the wireless communication module by simulating compliance with a target communication protocol; and
a data-sending unit configured to send, through the virtual module, the first audio data to a second electronic device;
wherein:
in response to the first electronic device being in a second mode, the first audio data is sent to a third electronic device for playback through the wireless communication module; and
the third electronic device communicates with the wireless communication module following the target communication protocol.

11. An electronic device with a computer-readable storage medium storing one or more computer programs that, when executed by one or more processors, the one or more computer programs perform an audio data processing method, comprising:
determining that a first electronic device is in a first mode, and obtain first audio data based on a wireless communication module of the first electronic device;
transmitting the first audio data to a virtual module of the first electronic device, the virtual module communicating with the wireless communication module by simulating compliance with a target communication protocol; and
sending, through the virtual module, the first audio data to a second electronic device;
wherein:
in response to the first electronic device being in a second mode, the first audio data is sent to a third electronic device for playback through the wireless communication module; and
the third electronic device communicates with the wireless communication module following the target communication protocol.

12. The device of claim 11, wherein transmitting the first audio data to the virtual module of the first electronic device includes:
transmitting the first audio data to a protocol stack of the first electronic device following the target communication protocol; and
transmitting the first audio data to the virtual module accessing the protocol stack through the protocol stack;
wherein:
in response to the second electronic device being in a second mode, the first audio data is sent to the third electronic device via the protocol stack and the wireless communication module and through a target wireless communication connection; and
the target wireless communication connection is a wireless connection established between the first electronic device and the third electronic device based on the target communication protocol.

13. The device of claim 11, further comprising:
determining an address identifier of the virtual module; and
establishing a connection between the virtual module and the wireless communication module based on the address identifier of the virtual module.

14. The device of claim 11, wherein obtaining the first audio data based on the wireless communication module of the first electronic device includes:
in response to a voice call application of the first electronic device being in a voice communication state, obtaining the first audio data based on the wireless communication module of the first electronic device.

15. The device of claim 14, wherein the method further includes:
in response to the voice call application of the first electronic device being not in a voice communication state, obtaining second audio data from an operating system of the first electronic device and transmitting the second audio data to the second electronic device.

16. The device of claim 11, wherein obtaining the first audio data based on the wireless communication module of the first electronic device includes at least one of:
obtaining the first audio data required for playback by an audio output application based on the wireless communication module of the first electronic device; or
obtaining the first audio data required for playback by a voice call application based on the wireless communication module of the first electronic device.

17. The device of claim 16, wherein sending, by the virtual module, the first audio data to the second electronic device includes:
in response to the first audio data being from the audio output application, processing the first audio data by the virtual module using a first sub-protocol of the target communication protocol and sending the processed first audio data to the second electronic device; and
in response to the first audio data being from the voice call application, processing the first audio data by the virtual module using a second sub-protocol of the target communication protocol and sending the processed first audio data to the second electronic device.

18. The device of claim 11, the method further includes:
obtaining third audio data sent by the second electronic device;
transmitting the third audio data to the wireless communication module through the virtual module; and
outputting the third audio data obtained by the wireless communication module.

19. The device of claim 18, wherein outputting the third audio data obtained by the wireless communication module includes:
in response to a target application of the third audio data being the voice communication application of the first electronic device, sending the third audio data to a voice communication processing module of the first electronic device, and outputting the third audio data through the voice communication processing module;
in response to the target application of the third audio data being the audio output application of the first electronic device, outputting the third audio data to an audio playback apparatus through the operating system.
